(19) United States
(12) Patent Application Publication
(10) Pub. No.: US 2022/0058848 A1
(43) Pub. Date: Feb. 24, 2022

(54) VIRTUAL AVATAR DRIVING METHOD AND APPARATUS, DEVICE, AND STORAGE MEDIUM

(71) Applicant: Beijing Baidu Netcom Science Technology Co., Ltd., Beijing (CN)

(72) Inventors: Haotian PENG, Beijing (CN); Ruizhi CHEN, Beijing (CN)

(73) Assignee: Beijing Baidu Netcom Science Technology Co., Ltd., Beijing (CN)

(21) Appl. No.: 17/516,769

(22) Filed: Nov. 2, 2021

(30) Foreign Application Priority Data
Nov. 30, 2020 (CN) 202011384844.2

(51) Int. Cl. G06T 13/40

(52) U.S. Cl. CPC G06T 13/40

(57) ABSTRACT

Provided are a virtual avatar driving method and apparatus, a device, and a storage medium. The virtual avatar driving method includes: determining reference pose data of each of bone nodes when driving a skinned mesh bone model of a virtual avatar to a target patch model with a same topology; synchronously driving the skinned mesh bone model according to the reference pose data of each of the bone nodes; and updating the reference pose data of each of the bone nodes for subsequently driving the skinned mesh bone model.

### CROSS-REFERENCE TO RELATED APPLICATION

This application claims priority to Chinese Patent Application No. 202011384844.2 filed Nov. 30, 2020, the disclosure of which is incorporated herein by reference in its entirety.

### TECHNICAL FIELD

The present application relates to the technical field of artificial intelligence, in particular, to the fields of computer vision, augmented reality, and deep learning, and specifically, to a virtual avatar driving method and apparatus, a device, and a storage medium.

### BACKGROUND

With the continuing development of artificial intelligence technologies, computer vision technologies came into being. The skinned mesh bone model of a virtual avatar can be driven by means of augmented reality in computer vision to simulate expressions or postures of a real avatar, thereby increasing use enjoyment of the user.

However, in the related art, there are problems of long processing time and low processing efficiency in the process of driving virtual avatar based on the real avatar, which degrades the use experience of the user.

### SUMMARY

The present application provides a more efficient virtual avatar driving method and apparatus, a device, and a storage medium.

According to an aspect of the present application, a virtual avatar driving method is provided. The method includes the steps described below.

Reference pose data of each of bone nodes when a skinned mesh bone model of a virtual avatar is driven to a target patch model with the same topology is determined.

The skinned mesh bone model is synchronously driven according to the reference pose data of each of the bone nodes.

The reference pose data of each of the bone nodes is updated for subsequently driving the skinned mesh bone model.

According to another aspect of the present application, a virtual avatar driving apparatus is provided. The apparatus includes a reference pose data determination module, a skinned mesh bone model driving module, and a reference pose data update module.

The reference pose data determination module is configured to determine reference pose data of each of bone nodes when a skinned mesh bone model of a virtual avatar is driven to a target patch model with the same topology.

The skinned mesh bone model driving module is configured to synchronously drive the skinned mesh bone model according to the reference pose data of each of the bone nodes.

The reference pose data update module is configured to update the reference pose data of each of the bone nodes for subsequently driving the skinned mesh bone model.

According to another aspect of the present application, an electronic device is further provided. The electronic device includes at least one processor; and a memory communicatively connected to the at least one processor.

The memory has instructions executable by the at least one processor stored thereon, where the instructions are executed by the at least one processor to enable the at least one processor to perform the virtual avatar driving method provided in any one of the embodiments of the present application.

According to another aspect of the present application, a non-transitory computer-readable storage medium is further provided. The non-transitory computer-readable storage medium has computer instructions stored thereon, where the computer instructions are configured to cause a computer to perform the virtual avatar driving method provided in any one of the embodiments of the present application.

According to the technology of the present application, the driving efficiency of virtual avatar when the expression or pose of a real avatar is simulated by driving a virtual avatar is improved.

It is to be understood that the content described in this part is neither intended to identify key or important features of embodiments of the present disclosure nor intended to limit the scope of the present disclosure. Other features of the present disclosure are easily understood from the description provided hereinafter.

### BRIEF DESCRIPTION OF DRAWINGS

The drawings are intended to provide a better understanding of the present scheme and not to limit the present application. In the drawings:

FIG. 1A is a flowchart of a virtual avatar driving method according to an embodiment of the present application;

FIG. 1B is a structural diagram of bone nodes and skinned meshes of a virtual avatar according to an embodiment of the present application;

FIG. 1C is a schematic diagram of an association relationship between bone nodes and skinned meshes according to an embodiment of the present application;

FIG. 1D is a schematic diagram of the influence of a bone node on a skinned mesh vertex of a child node according to an embodiment of the present application;

FIG. 2 is a flowchart of another virtual avatar driving method according to an embodiment of the present application;

FIG. 3 is a flowchart of another virtual avatar driving method according to an embodiment of the present application;

FIG. 4A is a flowchart of another virtual avatar driving method according to an embodiment of the present application;

FIG. 4B is a schematic diagram of a virtual avatar driving process according to an embodiment of the present application;

FIG. 5 is a structural diagram of a virtual avatar driving apparatus according to an embodiment of the present application; and

FIG. 6 is a block diagram of an electronic device for implementing the virtual avatar driving methods according to an embodiment of the present application.

### DETAILED DESCRIPTION

Exemplary embodiments of the present application, including details of embodiments of the present application, are described hereinafter in conjunction with the drawings to facilitate understanding. The exemplary embodiments are merely illustrative. Therefore, it will be realized by those having ordinary skill in the art that various changes and modifications may be made to the embodiments described herein without departing from the scope and spirit of the present application. Similarly, description of well-known functions and constructions is omitted hereinafter for clarity and conciseness.

Each virtual avatar driving method and virtual avatar driving apparatus provided in the present application is suitable for a case where the expression or pose of a real avatar is simulated through a virtual avatar in an application such as a camera application or a video application. Each virtual avatar driving method provided in the present application may be performed by a virtual avatar driving apparatus. The virtual avatar driving apparatus may be implemented by software and/or hardware and may be specifically configured in an electronic device. The electronic device may be a mobile terminal or a fixed terminal provided with an application having a virtual avatar stimulation function.

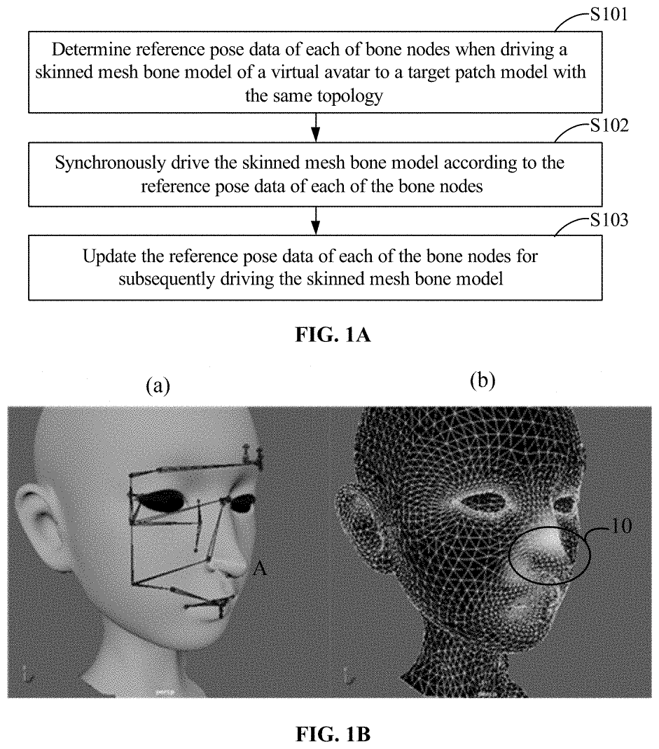

Referring to FIG. 1A which is a flowchart of a virtual avatar driving method, the method includes steps described below.

In step S101, reference pose data of each of bone nodes when a skinned mesh bone model of a virtual avatar is driven to a target patch model with the same topology is determined.

The virtual avatar may be understood as an avatar constructed based on a virtual character, a virtual animal, or a virtual plants, such as a cartoon avatar.

The skinned mesh bone model is a model structure constructed by technicians during the design of the virtual avatar and is used for uniquely representing the corresponding virtual avatar. The skinned mesh bone model may include two parts: bone nodes and a skinned mesh. The bone nodes may build a bone node tree according to the association relationship between nodes, to facilitate the search or use of bone nodes. The skinned mesh includes at least one skinned mesh vertex and is attached to the bone, and each skinned mesh vertex may be controlled by multiple bone nodes.

Referring to FIG. 1B, FIG. 1B is a structural diagram of bone nodes and skinned meshes of a virtual avatar according to an embodiment of the present application. The lines in the figure (a) represent the hierarchical structure between bone nodes, and the intersection points of the lines are bone nodes. The figure (b) illustrates a skinned mesh corresponding to the bone nodes in the figure (a). Since the same skinned mesh vertex may be controlled by multiple bone nodes, the degree of control of a bone node over a skinned mesh associated with the bone node may also be characterized through the grayscale in the skinned mesh area, that is, the skinned mesh weight. An area 10 characterizes the skinned mesh weight of the bone node A in the figure (a) to the associated skinned mesh through the grayscale, where the white weight is 1 and the black weight is 0.

The patch model is a model structure designed by technicians for the virtual avatar and includes only the skinned mesh part. The patch model with the same topology in the present application may be understood as a model which is, together with the skinned mesh bone model, constructed for the same virtual avatar. In both of the models, the number of skinned mesh vertexes is the same, the corresponding location of each skinned mesh vertex is the same, the connection sequence between the skinned mesh vertexes is the same, and the connection sequence of skinned mesh patches is also the same.

The target patch model may be understood as a patch model of the ideal virtual avatar obtained after the virtual avatar completely simulates the real avatar.

The target patch model may be a patch model obtained after the virtual avatar imitates the real avatar based on information such as the expression and/or pose of the real avatar. Other data such as the location information of each skinned mesh vertex in the patch model may be obtained by processing an image of the real avatar based on any three-dimensional animation processing manner in the related art. For example, the other data may be obtained by processing the image corresponding to the real avatar through a linear model constructed by multiple pre-constructed blend shape (BS) models.

The reference pose data is used for characterizing the pose data corresponding to each of the bone nodes in the skinned mesh bone model when an ideal virtual image consistent with the target patch model with the same topology is obtained after the pose transform is performed on the skinned mesh bone model of the virtual avatar. In order to reduce the complexity of the pose transform process, the pose transform is usually performed by adopting rigid transform which, for example, may include at least one of the following transforms: rotation, translation, or scaling.

In an optional embodiment, the step in which the reference pose data of each of bone nodes when the skinned mesh bone model of the virtual avatar is driven to the target patch model with the same topology is determined may be that the reference pose data of each of the bone nodes is determined according to current location information of a skinned mesh vertex associated with the each of the bone nodes in the skinned mesh bone model and target location information of a vertex in the target patch model, where the vertex has a same index as the each of the bone nodes, thereby completing the determination mechanism of the reference pose data and providing data support for the subsequent driving of the skinned mesh bone model.

It is to be noted that the determination manner of the reference pose data may also be implemented by one of the determination manners or a combination of at least two determination manners in the related art, and the specific determination manner of the reference pose data is not limited in the present application.

In an optional embodiment, the skinned mesh vertexes associated with a bone node may be the skinned mesh vertexes controlled by the bone node.

A bone node also has an influence on the location information of a skinned mesh vertex of a child node of the bone node, that is, the influence of the bone node on the skinned mesh vertex has the phenomenon of cross-node transfer. Therefore, in order to avoid the case where determination results of the finally determined reference pose data are inaccurate because the interaction between nodes is ignored and thus the accuracy of the final driving results of the skinned mesh bone model is affected, in an optional embodiment, the skinned mesh vertexes associated with a bone node, which are used during the determination of the reference pose data, may be set to include a skinned mesh vertex in a skinned mesh controlled by the bone node and a skinned mesh vertex in a skinned mesh controlled by at least one child node of the bone node in a bone node tree. The child node of the bone node may include at least one of a first-level child node, a second-level child node, or a higher-level child node of the bone node.

Referring to FIG. 1C, FIG. 1C illustrates a sequential parent-child relationship between a root node (Node_{Root}), a node E (Node_{E}), a node F (Node_{F}), a node G (Node_{G}), and a node H (Node_{H}) and a case of skinned meshes (corresponding to gray areas) associated with different nodes. It is to be noted that in the skinned mesh bone model, some bone nodes may not directly control any skinned mesh, that is, the number of skinned mesh vertexes directly controlled by these bone nodes is 0, such as the node F shown in FIG. 1C.

FIG. 1D illustrates that when the node G is adjusted, location information of a skinned mesh vertex 21 in the skinned mesh area 20 associate with the node G changes; and accordingly, the skinned mesh area 30 associated with the first-level child node (node H) of the node G also changes.

It is to be understood that, in order to reduce the amount of data computation of an electronic device for performing the virtual avatar driving method when performing the virtual avatar driving method, in an optional embodiment, the determination process of the reference pose data of each of the bone nodes may also be migrated to other computing devices associated with the electronic device. Accordingly, in the virtual avatar driving process, when the reference pose data needs to be determined, the reference pose data may just be obtained from the other computing devices.

In step S102, the skinned mesh bone model is synchronously driven according to the reference pose data of each of the bone nodes.

For example, for each of the bone nodes, a current bone driving coefficient for the skinned mesh bone model may be determined according to the previously determined reference pose data, and the skinned mesh bone model is synchronously driven according to the bone driving coefficient corresponding to each of the bone nodes so that the location information of the skinned mesh vertexes in the virtual avatar is changed, to enable the changed virtual avatar to gradually approximate to location information of the corresponding skinned mesh vertexes in the target patch model.

It is to be noted that, in the skinned mesh bone model driving process, since at least two bone nodes are associated with each other, that is, at least two bone nodes may directly or indirectly have an influence on the location information of the same skinned mesh vertex, when the skinned mesh bone model is driven, the skinned mesh bone model is synchronously driven through the reference pose data of all of the bone nodes. Therefore, the cooperation or restriction among the bone nodes can be taken into consideration in the driving process synchronously, thereby reducing the occurrence of repeated adjustments on the bone nodes and thus improving the driving efficiency.

In step S103, the reference pose data of each of the bone nodes is updated for subsequently driving the skinned mesh bone model.

Since in the skinned mesh bone model driving process, it is usually impossible to implement the simulation of a virtual avatar to a real avatar with one driving, that is, the driven skinned mesh bone model cannot match the target patch model of the ideal virtual avatar (the real avatar simulated by the virtual avatar) well, it is necessary to perform multiple times of iterative driving to enable the current virtual avatar corresponding to the driven skinned mesh bone model to gradually approximate to the ideal virtual avatar.

Since the location information of the skinned mesh vertex associated with each of the bone nodes in the driven skinned mesh bone model changes after the skinned mesh bone model is driven, when the skinned mesh bone model is subsequently driven, the reference pose data also changes. In order to achieve the continuous driving of the skinned mesh bone model and thus implement the presentation of the ideal virtual avatar, it is also necessary to re-determine the reference pose data corresponding to each of the bone nodes, that is, the reference pose data of each of the bone nodes needs to be updated, and then the skinned mesh bone model is subsequently driven according to the updated reference pose data.

In an optional embodiment, the step in which the reference pose data of each of the bone nodes is updated may be that reference pose information of each of the bone nodes when the driven skinned mesh bone model is driven to the target patch model with the same topology is determined.

For example, according to the location information of the skinned mesh vertex associated with each of the bone nodes in the driven skinned mesh bone model and the location information of the corresponding skinned mesh vertex in the target patch model with the same topology, the reference pose data of each of the bone nodes may be re-determined to update the reference pose data of each of the bone nodes, thereby providing data support for the subsequent driving of the skinned mesh bone model.

In the process of performing multiple times of iterative driving on the skinned mesh bone model, an iteration termination condition is usually set, and the current virtual avatar corresponding to the skinned mesh bone model obtained after the last driving is displayed to the user as the final avatar after simulating the real avatar.

In an optional embodiment, the iteration termination condition may be that the number of times of iteration reaches a set times threshold, where the set times threshold may be set by the technicians according to needs or empirical values.

In another optional embodiment, the iteration termination condition may also be determined according to an error between the current virtual avatar corresponding to the driven skinned mesh bone model and the ideal virtual avatar corresponding to the target patch model.

For example, a location error is determined according to current location information of a skinned mesh vertex associated with each of the bone nodes in the driven skinned mesh bone model and target location information of a vertex in the target patch model, where the vertex has a same index as the each of the bone nodes; whether an iteration termination condition is satisfied is determined according to the location error; if the iteration termination condition is satisfied, a driving operation on the skinned mesh bone model is terminated; and if the iteration termination condition is not satisfied, a reference pose transform data update operation continues to be executed, and then the skinned mesh bone model is driven according to the updated reference pose transform data. The location error may be a data difference value of the location information, a root mean square error of the location information, or other error data that may characterize the deviation between the current virtual avatar corresponding to the skinned mesh bone model and the ideal virtual avatar, which is not limited in the present application.

It is to be noted that, the deviation between the current virtual avatar and the ideal virtual avatar is characterized by the location error so that in the virtual avatar driving process, the matching degree of the current virtual avatar corresponding to the skinned mesh bone model and the ideal virtual avatar may be taken into account, ensuring the accuracy of the imitation results when the virtual avatar imitates the real avatar and thus enhancing the use experience of the user.

In an embodiment, if the location error is less than a set location error threshold, it is determined that the iteration termination condition is satisfied; and if the location error is not less than the set location error threshold, it is determined that the iteration termination condition is not satisfied. The set location error threshold may be set or adjusted by the technicians according to needs or empirical values.

If the location error is less than the set location error threshold, it is determined that the location error converges, that is, the current virtual avatar approximates to the ideal virtual avatar, and thus the iterative driving performed on the skinned mesh bone model may be terminated; and if the location error is not less than the set location error threshold, it is determined that the location error does not converge, that is, the current virtual avatar is far from the ideal virtual avatar, and thus the iterative driving needs to continue to be performed on the skinned mesh bone model.

It is to be understood that the determination of the iteration termination condition through the location error can avoid the waste of computing resources caused by the unnecessary iteration calculation when the location error has converged but still does not reach the iteration times threshold, thereby reducing the unnecessary consumption of computing resources while ensuring the matching degree between the driving results and the ideal virtual avatar.

In an embodiment, if a convergence trend of the location error changes from convergence to divergence, it is determined that the iteration termination condition is satisfied; and if the convergence trend of the location error does not change from convergence to divergence, it is determined that the iteration termination condition is not satisfied.

If the location error continuously decreases but is still not less than the set location error threshold, it is considered that the convergence trend of the location error is convergence; and if the value of the location error changes in reverse during the convergence process, that is, the value of the location error increases, at this point, it is considered that the convergence trend of the location error changes from convergence to divergence. In this case, if the skinned mesh bone model continues to be driven, the gap between the current virtual avatar and the ideal virtual avatar increases, which thus reduces the matching degree between the driving results and the ideal virtual avatar and also brings about the increase of computation amount. Therefore, the above-mentioned situation continues to be performed or is terminated according to the change of the convergence trend of the location error so that the effect of improving the accuracy of virtual avatar driving results while reducing the amount of data computation in the determination process.

In the embodiments of the present application, reference pose data of each of bone nodes when a skinned mesh bone model of a virtual avatar is driven to a target patch model with the same topology is determined, the skinned mesh bone model is synchronously driven according to the reference pose data of each of the bone nodes, and the reference pose data of each of the bone nodes is updated for subsequently driving the skinned mesh bone model. Through the proceeding technical scheme, the skinned mesh bone model is synchronously driven based on the reference pose data of each of the bone nodes so that the cooperation or restriction among at least two bone nodes can be taken into consideration, thereby reducing the occurrence of repeated adjustments on the skinned mesh bone model. Meanwhile, the skinned mesh bone model is synchronously driven based on the reference pose transform data of each of the bone nodes, which replaces the manner of performing iterative driving on each of the bone nodes in the related art, thereby reducing the amount of data computation in the virtual avatar driving process and thus improving the driving efficiency when the virtual avatar simulates the real avatar.

The reduction of the amount of data computation will be described in detail by using an example in which the real avatar is simulated by the virtual avatar through the iterative driving process of a skinned mesh bone model including m bone nodes and n skinned mesh vertexes. If the virtual avatar is driven by performing iteration on each of the bone nodes, for one complete iteration for all of the bone nodes, the amount of data computation is m*n; and if the number of times of iteration is p, the amount of data computation of the whole virtual avatar driving process is m*n*p. However, if the method of the present application is adopted, each iteration process requires all of the bone nodes to synchronously drive the skinned mesh bone model, then the amount of data computation for one complete iteration is m+n; and if the number of times of iteration is q, the amount of data computation of the whole virtual avatar driving process is (m+n)*q. Since the number n of skinned mesh vertexes in the skinned mesh bone model is far greater than the numbers of times of iteration times, p and q, the amount of data computation m*n*p is also far greater than the amount of data computation (m+n)*q. In addition, through the synchronous driving manner in the present application, the interaction between different bone nodes can be taken into consideration, thus avoiding the occurrence of repeated adjustments on the skinned mesh bone model, so the number of times of iteration q is usually less than the number of times of iteration p. Therefore, the amount of data computation (m+n)*q in the present application is much less than the amount of data computation m*n*p in the related art. Due to the reduction of the amount of data computation, the driving efficiency when the virtual avatar simulates the real avatar is also improved.

In each iteration process, if each bone node in the skinned mesh bone model is synchronously driven, the case of over-fitting usually occurs, which eventually leads to low accuracy of virtual avatar driving results. In order to take into account both the computation efficiency and computation result accuracy of the virtual avatar driving process, in an optional embodiment, the idea of the partial degree of driving may be introduced in a single iteration process, thereby reducing the occurrence of over-fitting in the single iteration process, avoiding the occurrence of over-fitting in the overall driving process, and improving the accuracy of the final driving results.

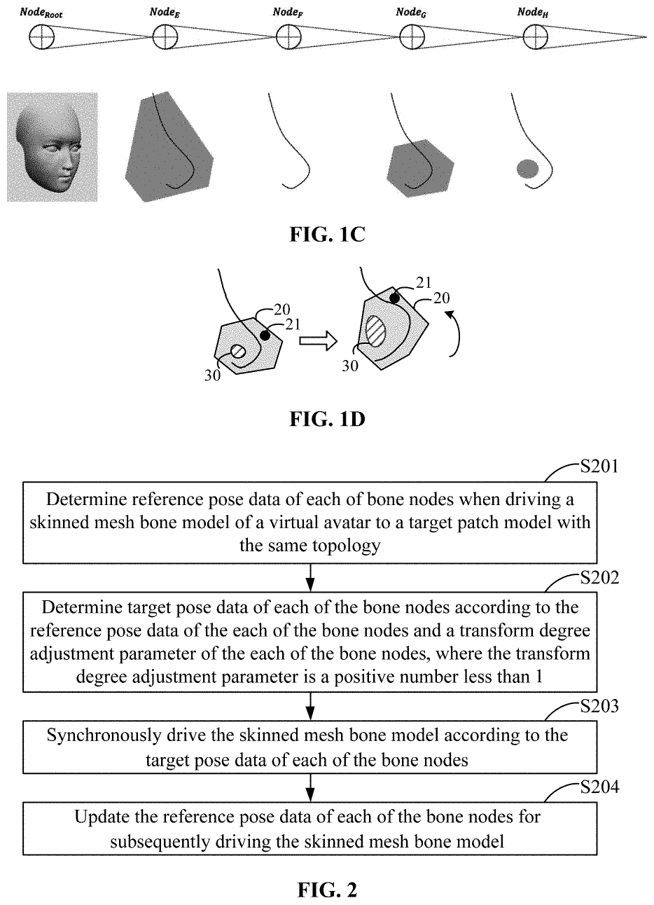

Further, referring to FIG. 2, a virtual avatar driving method is illustrated. The method includes the steps described below.

In step S201, reference pose data of each of bone nodes when a skinned mesh bone model of a virtual avatar is driven to a target patch model with the same topology is determined.

In step S202, target pose data of each of the bone nodes is determined according to the reference pose data of the each of the bone nodes and a transform degree adjustment parameter of the each of the bone nodes, where the transform degree adjustment parameter is a positive number less than 1.

The transform degree adjustment parameter is used for characterizing a driving degree of a single iteration process to the skinned mesh bone model. The target pose data is used for characterizing the pose data corresponding to each of the bone nodes in the skinned mesh bone model in a current virtual avatar expected to be presented in the local iteration process. The pose data may include at least one of the following rigid transform data: rotation data, translation data, or scaling data.

The transform degree adjustment parameter may be set or adjusted by the technicians according to needs or empirical values. In the present application, the transform degree adjustment parameter is set to a positive number less than 1 so that the skinned mesh bone model is partially driven based on the target pose data subsequently, thereby avoiding the occurrence of over-fitting caused by cooperation between bone nodes. It is to be noted that the transform degree adjustment parameters corresponding to different bone nodes may be the same or different; and in different iteration processes, the transform degree adjustment parameters corresponding to the same bone node may be the same or different.

The transform degree adjustment parameter may be pre-stored in an electronic device locally or other storage devices or cloud associated with the electronic device, and when the current pose transform data need to be determined, the transform degree adjustment parameter may be acquired and then used.

It is to be noted that, since in the bone node tree, a parent node has an influence on the location information of a skinned mesh vertex controlled by a child node, in the bone node tree, the bone nodes at higher levels have a relatively large influence on the skinned mesh vertexes in the entire skinned mesh bone model while the bone nodes at lower levels have a relatively small influence on the skinned mesh vertexes in the skinned mesh model. That is, when the skinned mesh bone model is driven according to the reference pose data of the bone nodes at higher levels, the possibility of the occurrence of over-fitting is higher than the possibility of the occurrence of over-fitting when the skinned mesh bone model is driven according to the reference pose data of the bone nodes at lower levels. Therefore, in an optional embodiment, the transform degree adjustment parameter of each of the bone nodes may be determined according to the level of the each of the bone nodes in the bone node tree. In general, the transform degree adjustment parameters corresponding to the bone nodes at higher levels are smaller while the transform degree adjustment parameters corresponding to the bone nodes at lower levels are larger.

It is to be understood that since bone nodes at different levels have different influences on the skinned mesh vertexes in the skinned mesh bone model, the transform degree adjustment parameters are set separately based on the levels of bone nodes in the bone node tree, which can strongly inhibit the bone nodes with large influence, avoid the occurrence of over-fitting, and thus lay a foundation for the improvement of the accuracy of the final skinned mesh bone model driving results. Meanwhile, the bone nodes with small influence are weakly inhibited, which avoids the increase of the number of times of iteration caused by excessive inhibition.

In an optional embodiment, the step in which the transform degree adjustment parameter of each of the bone nodes is determined according to the level of the each of the bone nodes in the bone node tree may be that the transform degree adjustment parameter of each of the bone nodes is determined according to the level of the each of the bone nodes in the bone node tree by using a pre-constructed adjustment parameter determination function. The adjustment parameter determination function is a decreasing function of the levels of the bone nodes, that is, with the increase of the levels of the bone nodes, the values of transform degree adjustment parameters decrease. The specific content of the adjustment parameter determination function may be determined by the technicians according to needs or empirical values, or repeatedly determined through a large number of tests. For example, the transform degree parameters of bone nodes at different levels in the skinned mesh bone model of the same virtual avatar may be fitted, and the adjustment parameter determination function is determined according to the fitting results. Of course, the adjustment parameter determination function may also be determined in other manners, which is not limited in the present application.

In order to reduce the amount of data computation in the virtual avatar driving process, in another optional embodiment, an adjustment parameter correspondence between bone nodes at different layers in the bone node tree and transform degree adjustment parameters may be preset, and then the transform degree adjustment parameter corresponding to each of the bone nodes may be subsequently searched and determined through the level of the each of the bone nodes in the bone node tree.

It is to be understood that with the presetting of the adjustment parameter correspondence, when the virtual avatar is driven, the transform degree adjustment parameter of the bone node may be searched and determined just through the level of the bone node in the bone node tree, and the calculation of the transform degree adjustment parameter is not required, thereby reducing the amount of data computation in the virtual avatar driving process.

In an embodiment, a pose adjustment parameter may be obtained by performing first set transform on the transform degree adjustment parameter; and according to the pose adjustment parameter, the reference pose data is weighted to obtain the target pose data. Alternatively, in an embodiment, to-be-processed pose data may be obtained by performing second set transform on the reference pose data; and according to the transform degree adjustment parameter, the to-be-processed pose data is weighted to obtain the target pose data. The first set transform and the second set transform may be separately implemented by the technicians according to the needs or experience by selecting an adaptive transform manner, and the specific transform manner is not limited in the present application. Of course, other manners in the related art may be used for adjusting the reference pose data as long as it is ensured that the skinned mesh bone model can be partially and controllably transformed when the skinned mesh bone model is driven according to the obtained target pose data, which is not limited in the embodiments of the present application.

In step S203, the skinned mesh bone model is synchronously driven according to the target pose data of each of the bone nodes.

It is to be understood that since the target pose data is determined based on a transform degree adjustment parameter less than 1, the transform trend of the target pose data to the skinned mesh bone model is less than the transform trend of the reference pose data to the skinned mesh bone model. Therefore, the skinned mesh bone model is synchronously driven according to the target pose data of each of the bone nodes, which reduces the occurrence of over-fitting.

In step S204, the reference pose data of each of the bone nodes is updated for subsequently driving the skinned mesh bone model.

Since the location information of the skinned mesh vertex associated with each of the bone nodes in the driven skinned mesh bone model has changed, when the skinned mesh bone model is driven to the target patch model with the same topology, the reference pose data of each of the bone nodes also change. In order to facilitate the subsequent iterative driving of the skinned mesh bone model, the reference pose data of each of the bone nodes need to be re-determined.

In an optional embodiment, the reference pose data of each of the bone nodes may be re-determined according to current location information of a skinned mesh vertex associated with the each of the bone nodes in the driven skinned mesh bone model and target location information of a vertex in the target patch model, where the vertex has a same index as the each of the bone nodes, so as to implement the update operation on the reference pose data.

It is to be noted that the update manner of the reference pose data may also be implemented by one of the update manners or a combination of at least two update manners in the related art, which is not limited in the present application.

In an embodiment, the skinned mesh vertexes associated with a bone node may include skinned mesh vertexes controlled by the bone node. Alternatively, in an embodiment, the skinned mesh vertexes associated with a bone node may further include skinned mesh vertexes controlled by at least one child node of the bone node. The child node of the bone node may include at least one of a first-level child node, a second-level child node, or a higher-level child node of the bone node.

After the reference pose data of each of the bone nodes is updated, the target pose data of each of the bone nodes may be determined respectively according to the pose data of the each of the bone nodes and the transform degree adjustment parameter of the each of the bone nodes, where the transform degree adjustment parameter is a positive number less than 1; and the skinned mesh bone model in the current iteration process is driven according to the target pose data of each of the bone nodes. The iteration is repeated until the iteration termination condition is reached, and the current virtual avatar corresponding to the skinned mesh bone model obtained by the last iteration is presented to the user as the final avatar. At this point, the matching degree between the current virtual avatar and the ideal virtual avatar is great.

In the present application, the operation of synchronously driving the skinned mesh bone model is refined into the operations in which the target pose data is determined respectively according to the reference pose data of each of the bone nodes and the transform degree adjustment parameter of each of the bone nodes, where the transform degree adjustment parameter is a positive number less than 1; and the skinned mesh bone model is synchronously driven according to the target pose data of each of the bone nodes. Therefore, the occurrence of over-fitting in the single driving process can be avoided, thereby laying a foundation for the improvement of the accuracy of the final skinned mesh bone model driving results. Meanwhile, the repeated adjustments on some bone nodes to different transform trends due to the case of over-fitting can be reduced, thereby reducing the amount of data computation in the virtual avatar driving process and improving the driving efficiency of the virtual avatar.

Since interpolation operation cannot be directly performed on the reference pose data, it is impossible to directly process the reference pose transform data according to the transform degree adjustment parameter, that is, a pose transform matrix of a bone node is directly weighted through the transform degree adjustment parameter of the bone node, and the obtained pose data may not achieve the effect of partially and controllably transforming of the skinned mesh bone model. In order to avoid the influence of the occurrence of the above case on the computation amount in the virtual avatar driving process and the accuracy of driving results, in an optional embodiment, the operation in which the target pose data of each of the bone nodes is determined according to the reference pose data of the each of the bone nodes and a transform degree adjustment parameter of the each of the bone nodes may be refined into the operations in which reference pose transform data of each of the bone is determined when the each of the bone nodes in the skinned mesh bone model is transformed to the reference pose data; target pose transform data of each of the bone nodes is determined according to the reference pose transform data of the each of the bone nodes and the transform degree adjustment parameter of the each of the bone nodes; and the target pose data of each of the bone nodes is determined according to current pose transform data of the each of the bone nodes and the target pose transform data of the each of the bone nodes, so as to complete the determination mechanism of the target pose data.

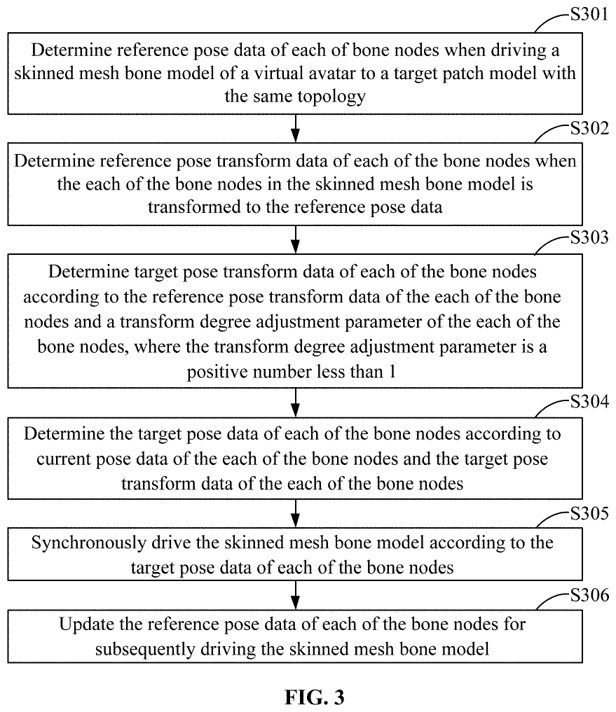

Referring to FIG. 3, a virtual avatar driving method is illustrated. The method includes the steps described below.

In step S301, reference pose data of each of bone nodes when a skinned mesh bone model of a virtual avatar is driven to a target patch model with the same topology is determined.

The reference pose data may be understood as pose data corresponding to each of the bone nodes in the skinned mesh bone model when the skinned mesh bone model presents the same virtual avatar as the target patch model. Since the pose data may include at least one of the following rigid transform data: rotation data, translation data, or scaling data, the reference pose data involved in the present application may include at least one of reference rotation data, reference translation data, or reference scaling data.

In step S302, reference pose transform data of each of the bone nodes when the each of the bone nodes in the skinned mesh bone model is transformed to the reference pose data is determined.

For example, the reference pose transform data of each of the bone nodes is determined according to current pose data and reference pose data of the each of the bone nodes in the skinned mesh bone model.

The current pose data may be understood as pose data corresponding to each of the bone nodes in the skinned mesh bone model after the previous driving and before the current driving. Since the pose data may include at least one of the following rigid transform data: rotation data, translation data, or scaling data, the current pose data involved in the present application may include at least one of current rotation data, current translation data, or current scaling data.

For example, if the reference pose data includes reference translation data, the current pose data includes current translation data, and the reference pose transform data includes reference translation data. Accordingly, the step in which the reference pose transform data of each of the bone nodes is determined according to current pose data and reference pose data of the each of the bone nodes in the skinned mesh bone model may be that the reference translation transform data is determined according to a data difference between the reference translation data and the current translation data.

For example, if the reference pose data includes reference scaling data, the current pose data includes current scaling data, and the reference pose transform data includes reference scaling data. Accordingly, the step in which the reference pose transform data of each of the bone nodes is determined according to current pose data and reference pose data of the each of the bone nodes in the skinned mesh bone model may be that the reference scaling transform data is determined according to a data difference between the reference scaling data and the current scaling data.

For example, if the reference pose data includes reference rotation data, the current pose data includes current rotation data, and the reference pose transform data includes reference quaternion transform data. It is to be noted that since the rotation data cannot implement smooth interpolation, it is necessary to convert the rotation data into quaternion data having a linear relationship and then processed. Accordingly, the step in which the reference pose transform data of each of the bone nodes is determined according to current pose data and reference pose data of the each of the bone nodes in the skinned mesh bone model may be that the current rotation data of each of the bone nodes is converted into current quaternion data, and the reference rotation data of the each of the bone nodes is converted into reference quaternion data; and according to a difference between the reference quaternion data and the current quaternion data, the reference quaternion transform data is determined. The conversion relationship between the rotation data and the quaternion data may be implemented in a manner of the related art, which is not limited in the present application.

In step S303, target pose transform data of each of the bone nodes is determined according to the reference pose transform data of the each of the bone nodes and a transform degree adjustment parameter of the each of the bone nodes, where the transform degree adjustment parameter is a positive number less than 1.

For example, if the reference pose transform data includes reference translation transform data, the target pose transform data includes target translation transform data. Accordingly, the step in which the target pose transform data of each of the bone nodes is determined according to the reference pose transform data of the each of the bone nodes and the transform degree adjustment parameter of the each of the bone nodes may be that the reference translation transform data of each of the bone nodes is weighted by using the transform degree adjustment parameter of the each of the bone nodes to obtain the target translation transform data of the each of the bone nodes.

For example, if the reference pose transform data includes reference scaling transform data, the target pose transform data includes target scaling transform data. Accordingly, the step in which the target pose transform data of each of the bone nodes is determined according to the reference pose transform data of the each of the bone nodes and the transform degree adjustment parameter of the each of the bone nodes may be that the reference scaling transform data of each of the bone nodes is weighted by using the transform degree adjustment parameter of the each of the bone nodes to obtain the target scaling transform data of the each of the bone nodes.

For example, if the reference pose transform data includes reference quaternion transform data, the target pose transform data includes target quaternion transform data. Accordingly, the step in which the target pose transform data of each of the bone nodes is determined according to the reference pose transform data of the each of the bone nodes and the transform degree adjustment parameter of the each of the bone nodes may be that the reference quaternion transform data of each of the bone nodes is weighted by using the transform degree adjustment parameter of the each of the bone nodes to obtain the target quaternion transform data of the each of the bone nodes.

In step S304, the target pose data of each of the bone nodes is determined according to current pose data of the each of the bone nodes and the target pose transform data of the each of the bone nodes.

For example, if the target pose transform data includes target translation transform data, the target pose data includes target translation data. Accordingly, the step in which the target pose data of each of the bone nodes is determined according to current pose data of the each of the bone nodes and the target pose transform data of the each of the bone nodes may be that the target translation data of each of the bone nodes is determined according to the sum of the current translation data of the each of the bone nodes and the target translation transform data of the each of the bone nodes.

For example, if the target pose transform data includes target scaling transform data, the target pose data includes target scaling data. Accordingly, the step in which the target pose data of each of the bone nodes is determined according to the current pose data of the each of the bone nodes and the target pose transform data of the each of the bone nodes may be that the target scaling data of each of the bone nodes is determined according to the sum of the current scaling data of the each of the bone nodes and the target scaling transform data of the each of the bone nodes.

For example, if the target pose transform data includes target quaternion transform data, the target pose data includes target rotation data. Accordingly, the step in which the target pose data of each of the bone nodes is determined according to the current pose data of the each of the bone nodes and the target pose transform data of the each of the bone nodes may be that the current rotation data of each of the bone nodes is converted into current quaternion data; target quaternion data is determined according to the sum of the current quaternion data and the target quaternion transform data; and the target quaternion data is converted into the target rotation data.

It is to be noted that in the present application, the controllable partial transform of the skinned mesh bone model in the rotation process may be achieved by converting the rotation data into quaternion data on which the interpolation operation can be performed. Of course, in the embodiments of the present application, the reference pose data on which the interpolation operation cannot be directly performed may also be converted into data in other forms in a manner of the related art, which is not limited in the embodiments of the present application.

In step S305, the skinned mesh bone model is synchronously driven according to the target pose data of each of the bone nodes.

The skinned mesh bone model is synchronously driven according to at least one of target translation data, target scaling data, or target rotation data of each of the bone nodes in the skinned mesh bone model.

It is to be noted that the synchronous driving of the skinned mesh bone model may be achieved by classifying types of target pose data and the skinned mesh bone model may be driven separately. For example, the skinned mesh bone model may be scaled according to the target scaling data of all of the bone nodes; the scaled skinned mesh bone model is rotated according to the target rotation data of all of the bone nodes; and the rotated skinned mesh bone model is translated according to the target translation data of all of the bone nodes.

In step S306, the reference pose data of each of the bone nodes is updated for subsequently driving the skinned mesh bone model.

In the embodiments of the present application, the determination process of the target pose data is refined into the following operations: reference pose transform data when each of the bone nodes in the skinned mesh bone model is transformed into reference pose data is determined; the target pose transform data of each of the bone nodes is determined according to the reference pose transform data and a transform degree adjustment parameter of the each of the bone node; and the target pose data of each of the bone nodes is determined according to the current pose data and the target pose transform data of the each of the bone nodes. With the introduction of the reference pose transform data, the partial transform trend of the reference pose data is determined, which provides data support for the subsequent determination of the target pose data, improves the accuracy of the determined target pose data, and thus improves the accuracy and controllability of the virtual avatar driving result.

On the basis of the preceding technical schemes, the present application further provides a preferred embodiment of the virtual avatar driving method.

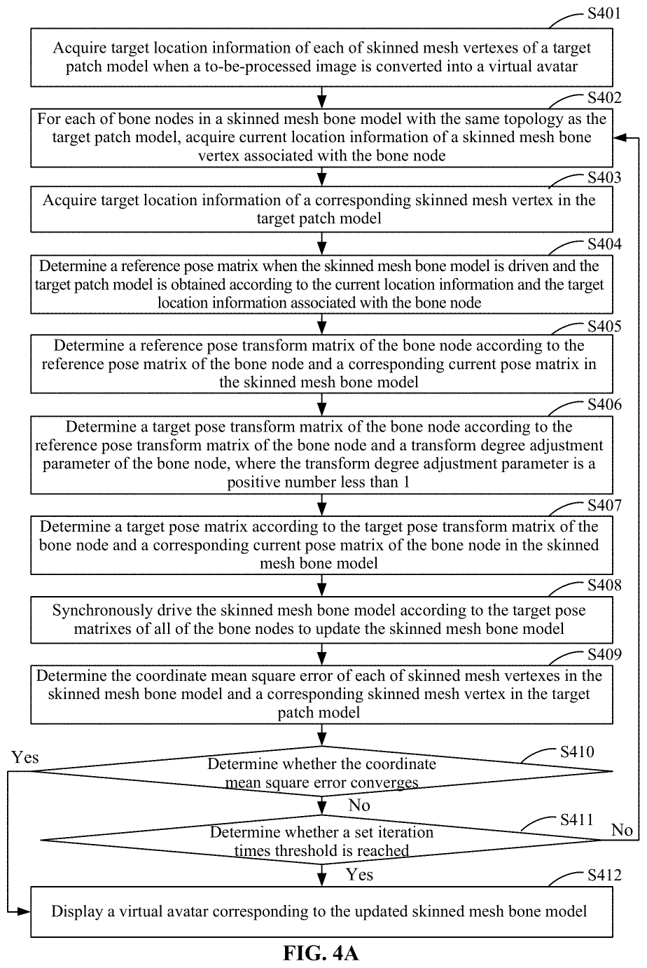

Further, referring to FIG. 4A, a virtual avatar driving method includes the steps described below.

In step S401, target location information of each of skinned mesh vertexes of a target patch model when a to-be-processed image is converted into a virtual avatar is acquired.

The to-be-processed image is a real image uploaded by the user.

For example, the target location information of each of the skinned mesh vertexes in the target patch model may be obtained by processing the to-be-processed image through a linear model constructed by multiple pre-constructed BS models.

In step S402, for each of bone nodes in a skinned mesh bone model with the same topology as the target patch model, current location information of a skinned mesh bone vertex associated with the bone node is acquired.

The skinned mesh vertexes associated with a bone node include a skinned mesh vertex controlled by the bone node itself and a skinned mesh vertex controlled by each of child nodes of the bone node.

In step S403, target location information of a corresponding skinned mesh vertex in the target patch model is acquired.

In step S404, a reference pose matrix when the skinned mesh bone model is driven and the target patch model is obtained is determined according to the current location information and the target location information associated with the bone node.

In step S405, a reference pose transform matrix of the bone node is determined according to the reference pose matrix of the bone node and a corresponding current pose matrix in the skinned mesh bone model.

In step S406, a target pose transform matrix of the bone node is determined according to the reference pose transform matrix of the bone node and a transform degree adjustment parameter of the bone node, where the transform degree adjustment parameter is a positive number less than 1.

For example, the transform degree adjustment parameter of the bone node may be determined according to the level of the bone node in a bone node tree of a virtual avatar. For example, the transform degree adjustment parameter corresponding to the level of the bone node is searched according to a pre-constructed adjustment parameter correspondence. The adjustment parameter correspondence may be set or adjusted by the technicians according to needs or experience.

In step S407, a target pose matrix is determined according to the target pose transform matrix of the bone node and a corresponding current pose matrix of the bone node in the skinned mesh bone model.

It is to be noted that when the target pose matrix of each of the bone nodes is determined, the computation sequence of the bone nodes is not limited.

For example, the pose matrix includes a translation matrix, a scaling matrix, or a rotation matrix.

If the pose matrix includes a translation matrix, for each of the bone nodes, a reference translation transform matrix of the bone node may be determined according to a reference translation matrix of the bone node and a corresponding current translation matrix in the skinned mesh bone model; the product of the reference translation transform matrix and the transform degree adjustment parameter is taken as a target translation transform matrix; and the sum of the target translation transform matrix and a corresponding current translation matrix of the bone node in the skinned mesh bone model is taken as a target translation matrix.

If the pose matrix includes a scaling matrix, for each of the bone nodes, a reference scaling transform matrix of the bone node may be determined according to a reference scaling matrix of the bone node and a corresponding current scaling matrix in the skinned mesh bone model; the product of the reference scaling transform matrix and the transform degree adjustment parameter is taken as a target scaling transform matrix; and the sum of the target scaling transform matrix and a corresponding current scaling matrix of the bone node in the skinned mesh bone model is taken as a target scaling matrix.

If the pose matrix includes a rotation matrix, for each of the bone nodes, a reference rotation matrix of the bone node is converted into a reference quaternion matrix, and a corresponding current rotation matrix of the bone node in the skinned mesh bone model is converted into a current quaternion matrix; the difference between the reference quaternion matrix and a current quaternion matrix is taken as a reference quaternion transform matrix; the product of the reference quaternion transform matrix and the transform degree adjustment parameter is taken as a target quaternion transform matrix; the sum of the target quaternion transform matrix and a current quaternion matrix is taken as a target quaternion matrix; and the target quaternion matrix is converted into a target rotation matrix.

In step S408, the skinned mesh bone model is synchronously driven according to the target pose matrixes of all of the bone nodes to update the skinned mesh bone model.

The skinned mesh bone model is synchronously driven according to the target scaling matrixes of all of the bone nodes; the scaled skinned mesh bone model is synchronously driven according to the target rotation matrixes of all of the bone nodes; and the rotated skinned mesh bone model is synchronously driven according to the target translation matrixes of all of the bone nodes.

In step S409, the coordinate mean square error of each of skinned mesh vertexes in the skinned mesh bone model and a corresponding skinned mesh vertex in the target patch model is determined.

In step S410, whether the coordinate mean square error converges is determined; if it is determined that the coordinate mean square error does not converge, execute step S411; and if it is determined that the coordinate mean square error converges, execute step S412.

For example, if that coordinate mean square error is less than a set error threshold, it is determined that the coordinate mean square error converges; and if the coordinate mean square error is not less than the set error threshold, it is determined that the coordinate mean square error does not converge. The set error threshold may be set or adjusted by the technicians according to needs or empirical values.

In step S411, whether a set iteration times threshold is reached is determined; if it is determined that the set iteration times threshold is not reached, return to execute step S402; and if it is determined that the set iteration times threshold is reached, execute step S412.

The set iteration times threshold may be set or adjusted by the technicians according to needs or empirical values.

In step S412, a virtual avatar corresponding to the updated skinned mesh bone model is displayed.

In the present application, with the manner of synchronously driving the skinned mesh bone model through all of the bone nodes in the single iteration process, the problem that the computation of other bone nodes and the subsequent iteration computation are inaccurate due to over-fitting caused by calculating of a single node and driving the skinned mesh bone model is avoided, and the calculation speed of the algorithm is improved (less than seconds). Meanwhile, with the introduction of the transform degree adjustment parameter, the gradual approximation to the target patch model in the virtual avatar driving process is achieved, and the driving effect is significantly improved.

Referring to the schematic diagram of the virtual avatar driving process shown in FIG. 4B, figure (a) is an effect diagram of the target patch model; and figures (b) to (f) are schematic diagrams of virtual avatars corresponding to a skinned mesh bone model with the same topology as the target patch model when the skinned mesh bone model is iterated 1, 3, 5, 7 and 10 times. Through the comparison, it can be seen that with the gradual increase of iteration times, the virtual avatars (such as canthi, nasal tip, and corners of the mouth) corresponding to the skinned mesh bone model gradually approximate the ideal virtual avatar corresponding to the target patch model.

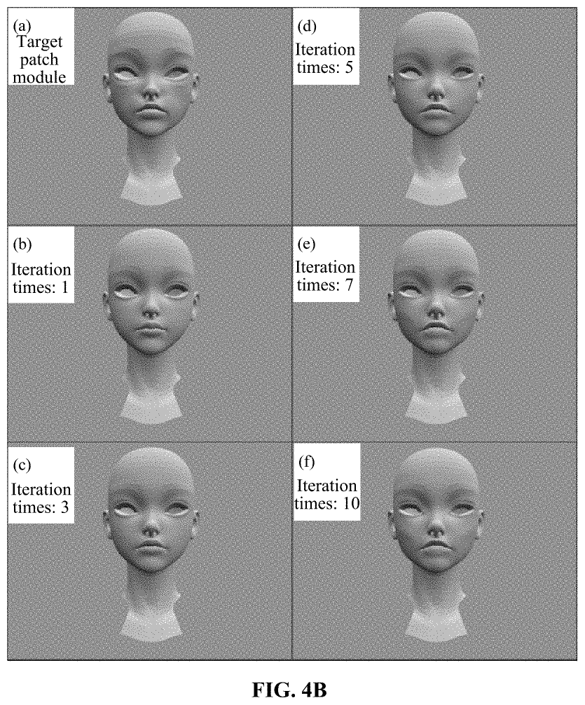

As the implementation of the preceding virtual avatar driving methods, the present application further provides an embodiment of a virtual apparatus for implementing the virtual avatar driving method. Further, referring to FIG. 5, a virtual avatar driving apparatus 500 includes a reference pose data determination module 501, a skinned mesh bone model driving module 502, and a reference pose data update module 503.

The reference pose data determination module 501 is configured to determine reference pose data of each of bone nodes when a skinned mesh bone model of a virtual avatar is driven to a target patch model with the same topology.

The skinned mesh bone model driving module 502 is configured to synchronously drive the skinned mesh bone model according to the reference pose data of each of the bone nodes.

The reference pose data update module 503 is configured to update the reference pose data of each of the bone nodes for subsequently driving the skinned mesh bone model.

In the embodiments of the present application, the reference pose data determination module determines reference pose data of each of bone nodes when a skinned mesh bone model of a virtual avatar is driven to a target patch model with the same topology, the skinned mesh bone model driving module synchronously drives the skinned mesh bone model according to the reference pose data of each of the bone nodes, and the reference pose data update module updates the reference pose data of each of the bone nodes for subsequently driving the skinned mesh bone model. Through the proceeding technical scheme, the skinned mesh bone model is synchronously driven based on the reference pose data of each of the bone nodes so that the cooperation or restriction among at least two bone nodes can be taken into consideration, thereby reducing the occurrence of repeated adjustments on the skinned mesh bone model. Meanwhile, the skinned mesh bone model is synchronously driven based on the reference pose transform data of each of the bone nodes, which replaces the manner of performing iterative driving on each of the bone nodes in the related art, thereby reducing the amount of data computation in the virtual avatar driving process and thus improving the driving efficiency when the virtual avatar simulates the real avatar.

In an optional embodiment, the skinned mesh bone model driving module 502 includes a target pose data determination unit and a skinned mesh bone model driving unit.

The target pose data determination unit is configured to determine target pose data of each of the bone nodes according to the reference pose data of the each of the bone nodes and a transform degree adjustment parameter of the each of the bone nodes, where the transform degree adjustment parameter is a positive number less than 1.

The skinned mesh bone model driving unit is configured to synchronously drive the skinned mesh bone model according to the target pose data of the each of the bone nodes.

In an optional embodiment, the apparatus further includes a transform degree adjustment parameter determination module.

The transform degree adjustment parameter determination module is configured to determine the transform degree adjustment parameter of each of the bone nodes according to a level of the each of the bone nodes in a bone node tree.

In an optional embodiment, the transform degree adjustment parameter determination module includes a transform degree adjustment parameter determination unit.

The transform degree adjustment parameter determination unit is configured to determine the transform degree adjustment parameter of each of the bone nodes according to an adjustment parameter correspondence and the level of the each of the bone nodes in the bone node tree.

In an optional embodiment, the target pose data determination unit includes a reference pose transform data determination sub-unit, a target pose transform data determination sub-unit, and a target pose data determination sub-unit.

The reference pose transform data determination sub-unit is configured to determine reference pose transform data of each of the bone nodes in the skinned mesh bone model when the each of the bone nodes in the skinned mesh bone model is transformed to the reference pose data.

The target pose transform data determination sub-unit is configured to determine target pose transform data of each of the bone nodes according to the reference pose transform data of the each of the bone nodes and the transform degree adjustment parameter of the each of the bone nodes.

The target pose data determination sub-unit is configured to determining the target pose data of each of the bone nodes according to current pose data of the each of the bone nodes and the target pose transform data of the each of the bone nodes.

In an optional embodiment, the reference pose data includes at least one of reference translation data, reference scaling data, or reference rotation data.

The reference pose transform data includes at least one of reference translation transform data, reference scaling transform data, or reference quaternion transform data.

The target pose transform data includes at least one of target translation transform data, target scaling transform data, or target quaternion transform data.

The target pose data includes at least one of target translation data, target scaling data, or target rotation data.

In an optional embodiment, the reference pose data determination module 501 includes a reference pose data determination unit.

The reference pose data determination unit is configured to determine the reference pose data of each of the bone nodes according to current location information of a skinned mesh vertex associated with the each of the bone nodes in the skinned mesh bone model and target location information of a vertex in the target patch model, where the vertex has a same index as the each of the bone nodes.

In an optional embodiment, skinned mesh vertexes associated with a bone node include a skinned mesh vertex in a skinned mesh controlled by the bone node and a skinned mesh vertex in a skinned mesh controlled by at least one child node of the bone node in a bone node tree.

In an optional embodiment, the apparatus further includes a location error determination module, an iteration termination condition determination module, and a determination result triggering module.

The location error determination module is configured to, after the skinned mesh bone model is synchronously driven according to the reference pose data of each of the bone nodes and before the reference transform pose data of each of the bone nodes is updated, determine a location error according to current location information of a skinned mesh vertex associated with each of the bone nodes in the driven skinned mesh bone model and target location information of a vertex in the target patch model, where the vertex has a same index as the each of the bone nodes.

The iteration termination condition determination module is configured to determine whether an iteration termination condition is satisfied according to the location error.

The determination result triggering module is configured to, if the iteration termination condition is satisfied, terminate an execution; and if the iteration termination condition is not satisfied, continue to execute a reference pose transform data update operation.

In an optional embodiment, the iteration termination condition includes that the location error is less than a set location error threshold and/or that a convergence trend of the location error changes from convergence to divergence.

The preceding virtual avatar driving apparatus may execute the virtual avatar driving method provided by any one of the embodiments of the present application and has functional modules and beneficial effects corresponding to the execution of the virtual avatar driving method.

According to the embodiments of the present application, the present application further provides an electronic device and a readable storage medium.

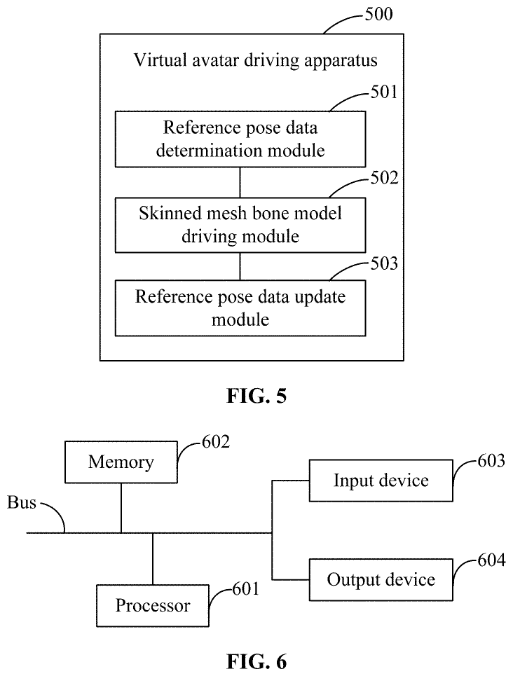

As shown in FIG. 6, FIG. 6 is a block diagram of an electronic device for implementing the virtual avatar driving methods according to an embodiment of the present application. The electronic device is intended to represent various forms of digital computer, for example, a laptop computer, a desktop computer, a worktable, a personal digital assistant, a server, a blade server, a mainframe computer or another applicable computer. The electronic device may also represent various forms of mobile device, for example, a personal digital assistant, a cellphone, a smartphone, a wearable device or another similar computing device. Herein the shown components, the connections and relationships between these components, and the functions of these components are illustrative only and are not intended to limit the implementation of the present application as described and/or claimed herein.

As shown in FIG. 6, the electronic device includes one or more processors 601, a memory 602, and interfaces for connecting various components, including a high-speed interface and a low-speed interface. The various components are interconnected to each other by different buses and may be mounted on a common mainboard or in other manners as desired. The processor may process instructions executed in the electronic device, including instructions stored in or on the memory to make graphic information of a GUI displayed on an external input/output device (for example, a display device coupled to an interface). In other implementations, if required, multiple processors and/or multiple buses may be used with multiple memories. Similarly, multiple electronic devices may be connected, each providing some necessary operations (and, for example, serving as a server array, a set of blade servers or a multi-processor system). FIG. 6 shows one processor 601 by way of example.

The memory 602 is the non-transitory computer-readable storage medium provided in the present application. The memory has instructions executable by at least one processor stored thereon to cause the at least one processor to perform the virtual avatar driving method provided in the present application. The non-transitory computer-readable storage medium of the present application has computer instructions stored thereon for causing a computer to perform the virtual avatar driving method provided in the present application.

The memory 602 as a non-transitory computer-readable storage medium is configured to store a non-transitory software program, a non-transitory computer-executable program and modules, for example, program instructions/modules corresponding to the virtual avatar driving method provided in the embodiments of the present application (for example, the reference pose data determination module 501, the skinned mesh bone model driving module 502, and the reference pose data update module 503 shown in FIG. 5). The processor 601 executes non-transitory software programs, instructions, and modules stored in the memory 602 to execute the various function applications and data processing of a server, that is, implement the virtual avatar driving method provided in the preceding method embodiments.

The memory 602 may include a program storage region and a data storage region. The program storage region may store an operating system and an application program required by at least one function. The data storage region may store data created based on the use of the electronic device for performing the virtual avatar driving method. Additionally, the memory 602 may include a high-speed random-access memory and a non-transitory memory, for example, at least one disk memory, a flash memory or another non-transitory solid-state memory. In some embodiments, the memory 602 optionally includes memories disposed remote from the processor 601, and these remote memories may be connected, through a network, to the electronic device for performing the virtual avatar driving method. Examples of the preceding network include, but are not limited to, the Internet, an intranet, a local area network, a mobile communication network, and a combination thereof.

The electronic device for performing the virtual avatar driving method may further include an input device 603 and an output device 604. The processor 601, the memory 602, the input device 603, and the output device 604 may be connected by a bus or in other manners. FIG. 6 uses connection by a bus as an example.

The input device 603 may receive input number or character information and generate key signal input related to user settings and function control of the electronic device for implementing the virtual avatar driving method. The input device 603 may be, for example, a touchscreen, a keypad, a mouse, a trackpad, a touchpad, a pointing stick, one or more mouse buttons, a trackball or a joystick. The output device 604 may include, for example, a display device, an auxiliary lighting device (for example, a light-emitting diode (LED)) or a haptic feedback device (for example, a vibration motor). The display device may include, but is not limited to, a liquid-crystal display (LCD), an LED display, and a plasma display. In some embodiments, the display device may be a touchscreen.

Various implementations of the systems and techniques described herein may be implemented in digital electronic circuitry, integrated circuitry, an application-specific integrated circuit (ASIC), computer hardware, firmware, software and/or a combination thereof. The various implementations may include implementations in one or more computer programs. The one or more computer programs are executable and/or interpretable on a programmable system including at least one programmable processor. The programmable processor may be a dedicated or general-purpose programmable processor for receiving data and instructions from a memory system, at least one input device and at least one output device and transmitting data and instructions to the memory system, the at least one input device and the at least one output device.

These computing programs (also referred to as programs, software, software applications or codes) include machine instructions of a programmable processor. These computing programs may be implemented in a high-level procedural and/or object-oriented programming language and/or in an assembly/machine language. As used herein, the term “machine-readable medium” or “computer-readable medium” refers to any computer program product, device and/or apparatus (for example, a magnetic disk, an optical disk, a memory or a programmable logic device (PLD)) for providing machine instructions and/or data for a programmable processor, including a machine-readable medium for receiving machine instructions as machine-readable signals. The term “machine-readable signal” refers to any signal used in providing machine instructions and/or data for a programmable processor.

In order to provide interaction with a user, the systems and techniques described herein may be implemented on a computer. The computer has a display device (for example, a cathode-ray tube (CRT) or an LCD monitor) for displaying information to the user and a keyboard and a pointing device (for example, a mouse or a trackball) through which the user may provide input for the computer. Other types of devices may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system (for example, a data server) including a back-end component, a computing system (for example, an application server) including a middleware component, a computing system (for example, a user computer having a graphical user interface or a web browser through which a user may interact with implementations of the systems and techniques described herein) including a front-end component or a computing system including any combination of such back-end, middleware or front-end components. Components of a system may be interconnected by any form or medium of digital data communication (for example, a communication network). Examples of the communication network include a local area network (LAN), a wide area network (WAN), the Internet, and a blockchain network.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a conventional physical host and a conventional virtual private server (VPS) service. The server may also be a server of a distributed system, or a server combined with blockchain.

Artificial intelligence is a discipline that studies making computers simulate some thinking processes and intelligent behaviors (such as learning, reasoning, thinking, and planning) of humans. There are both hardware-level technologies and software-level technologies. The artificial intelligence hardware technologies generally include technologies such as sensors, special artificial intelligence chips, cloud computing, distributed storage, and big data processing. The artificial intelligence software technologies mainly include computer vision technology, speech recognition technology, natural language processing technology, machine learning/deep learning technology, big data processing technology, knowledge graph technology, and the like.

According to the technical schemes of the embodiments of the present application, the skinned mesh bone model is synchronously driven based on the reference pose data of each of the bone nodes so that the cooperation or restriction among at least two bone nodes can be taken into consideration, thereby reducing the occurrence of repeated adjustments on the skinned mesh bone model. Meanwhile, the skinned mesh bone model is synchronously driven based on the reference pose transform data of each of the bone nodes, which replaces the manner of performing iterative driving on each of the bone nodes in the related art, thereby reducing the amount of data computation in the virtual avatar driving process and thus improving the driving efficiency when the virtual avatar simulates the real avatar.

It is to be understood that various forms of the preceding flows may be used, with steps reordered, added or deleted. For example, the steps described in the present application may be executed in parallel, in sequence or in a different order as long as the desired result of the technical scheme disclosed in the present application is achieved. The execution sequence of these steps is not limited herein.

The scope of the present application is not limited to the preceding implementations. It is to be understood by those skilled in the art that various modifications, combinations, sub-combinations, and substitutions may be made depending on design requirements and other factors. Any modification, equivalent substitution, improvement and the like made within the spirit and principle of the present application is within the scope of the present application.

What is claimed is:

1. A virtual avatar driving method, comprising:
determining reference pose data of each of bone nodes when driving a skinned mesh bone model of a virtual avatar to a target patch model with a same topology;
synchronously driving the skinned mesh bone model according to the reference pose data of each of the bone nodes; and
updating the reference pose data of each of the bone nodes for subsequently driving the skinned mesh bone model.

2. The method according to claim 1, wherein synchronously driving the skinned mesh bone model according to the reference pose data of the each of the bone nodes comprises:
determining target pose data of each of the bone nodes according to the reference pose data of the each of the bone nodes and a transform degree adjustment parameter of the each of the bone nodes; wherein the transform degree adjustment parameter is a positive number less than 1; and
synchronously driving the skinned mesh bone model according to the target pose data of each of the bone nodes.

3. The method according to claim 2, wherein the transform degree adjustment parameter of each of the bone nodes is determined in the following manner:
determining the transform degree adjustment parameter of each of the bone nodes according to a level of the each of the bone nodes in a bone node tree.

4. The method according to claim 3, wherein determining the transform degree adjustment parameter of the each of the bone nodes according to the level of the each of the bone nodes in the bone node tree comprises:
determining the transform degree adjustment parameter of each of the bone nodes according to an adjustment parameter correspondence and through the level of the each of the bone nodes in the bone node tree.

5. The method according to claim 2, wherein determining the target pose data of the each of the bone nodes according to the reference pose data of the each of the bone nodes and the transform degree adjustment parameter of the each of the bone nodes comprises:
determining reference pose transform data of each of the bone nodes in the skinned mesh bone model when the each of the bone nodes in the skinned mesh bone model is transformed to the reference pose data;
determining target pose transform data of each of the bone nodes according to the reference pose transform data of the each of the bone nodes and the transform degree adjustment parameter of the each of the bone nodes; and
determining the target pose data of each of the bone nodes according to current pose data of the each of the bone nodes and the target pose transform data of the each of the bone nodes.

6. The method according to claim 5, wherein the reference pose data comprises at least one of reference translation data, reference scaling data, or reference rotation data;
the reference pose transform data comprises at least one of reference translation transform data, reference scaling transform data, or reference quaternion transform data;
the target pose transform data comprises at least one of target translation transform data, target scaling transform data, or target quaternion transform data; and
the target pose data comprises at least one of target translation data, target scaling data, or target rotation data.

7. The method according to claim 1, wherein determining the reference pose data of the each of the bone nodes when driving the skinned mesh bone model of the virtual avatar to the target patch model with the same topology comprises:
determining the reference pose data of each of the bone nodes according to current location information of a skinned mesh vertex associated with the each of the bone nodes in the skinned mesh bone model and target location information of a vertex in the target patch model, wherein the vertex has a same index as the each of bone nodes in the skinned mesh bone model.

8. The method according to claim 7, wherein skinned mesh vertexes associated with a bone node comprise: a skinned mesh vertex in a skinned mesh controlled by the bone node and a skinned mesh vertex in a skinned mesh controlled by at least one child node of the bone node in a bone node tree.

9. The method according to claim 1, after synchronously driving the skinned mesh bone model according to the reference pose data of each of the bone nodes and before updating the reference pose data of each of the bone nodes, further comprising:
determining a location error according to current location information of a skinned mesh vertex associated with each of the bone nodes in the driven skinned mesh bone model and target location information of a vertex in the target patch model, wherein the vertex has a same index as the each of the bone nodes in the driven skinned mesh bone model;
determining whether an iteration termination condition is satisfied according to the location error; and
in response to determining that the iteration termination condition is satisfied, terminating an execution; in response to determining that the iteration termination condition is not satisfied, continuing to execute a reference pose transform data update operation.

10. The method according to claim 9, wherein the iteration termination condition comprises that the location error is less than a set location error threshold and/or that a convergence trend of the location error changes from convergence to divergence.

11. An electronic device, comprising:
at least one processor; and
a memory communicatively connected to the at least one processor;
wherein the memory has instructions executable by the at least one processor stored thereon, wherein the instructions are executed by the at least one processor to enable the at least one processor to perform:
determining reference pose data of each of bone nodes when driving a skinned mesh bone model of a virtual avatar to a target patch model with a same topology;
synchronously driving the skinned mesh bone model according to the reference pose data of each of the bone nodes; and
updating the reference pose data of each of the bone nodes for subsequently driving the skinned mesh bone model.

12. The electronic device according to claim 11, wherein synchronously driving the skinned mesh bone model according to the reference pose data of the each of the bone nodes comprises:
determining target pose data of each of the bone nodes according to the reference pose data of the each of the bone nodes and a transform degree adjustment parameter of the each of the bone nodes; wherein the transform degree adjustment parameter is a positive number less than 1; and
synchronously driving the skinned mesh bone model according to the target pose data of each of the bone nodes.

13. The electronic device according to claim 12, wherein the transform degree adjustment parameter of each of the bone nodes is determined in the following manner:
determining the transform degree adjustment parameter of each of the bone nodes according to a level of the each of the bone nodes in a bone node tree.

14. The electronic device according to claim 13, wherein determining the transform degree adjustment parameter of the each of the bone nodes according to the level of the each of the bone nodes in the bone node tree comprises:
determining the transform degree adjustment parameter of each of the bone nodes according to an adjustment parameter correspondence and through the level of the each of the bone nodes in the bone node tree.

15. The electronic device according to claim 12, wherein determining the target pose data of the each of the bone nodes according to the reference pose data of the each of the bone nodes and the transform degree adjustment parameter of the each of the bone nodes comprises:
determining reference pose transform data of each of the bone nodes in the skinned mesh bone model when the each of the bone nodes in the skinned mesh bone model is transformed to the reference pose data;
determining target pose transform data of each of the bone nodes according to the reference pose transform data of the each of the bone nodes and the transform degree adjustment parameter of the each of the bone nodes; and
determining the target pose data of each of the bone nodes according to current pose data of the each of the bone nodes and the target pose transform data of the each of the bone nodes.

16. The electronic device according to claim 15, wherein the reference pose data comprises at least one of reference translation data, reference scaling data, or reference rotation data;
the reference pose transform data comprises at least one of reference translation transform data, reference scaling transform data, or reference quaternion transform data;
the target pose transform data comprises at least one of target translation transform data, target scaling transform data, or target quaternion transform data; and
the target pose data comprises at least one of target translation data, target scaling data, or target rotation data.

17. The electronic device according to claim 11, wherein determining the reference pose data of the each of the bone nodes when driving the skinned mesh bone model of the virtual avatar to the target patch model with the same topology comprises:
determining the reference pose data of each of the bone nodes according to current location information of a skinned mesh vertex associated with the each of the bone nodes in the skinned mesh bone model and target location information of a vertex in the target patch model, wherein the vertex has a same index as the each of bone nodes in the skinned mesh bone model.

18. The electronic device according to claim 17, wherein skinned mesh vertexes associated with a bone node comprise: a skinned mesh vertex in a skinned mesh controlled by the bone node and a skinned mesh vertex in a skinned mesh controlled by at least one child node of the bone node in a bone node tree.

19. The electronic device according to claim 11, after synchronously driving the skinned mesh bone model according to the reference pose data of each of the bone nodes and before updating the reference pose data of each of the bone nodes, further performing:
determining a location error according to current location information of a skinned mesh vertex associated with each of the bone nodes in the driven skinned mesh bone model and target location information of a vertex in the target patch model, wherein the vertex has a same index as the each of the bone nodes in the driven skinned mesh bone model;
determining whether an iteration termination condition is satisfied according to the location error; and
in response to determining that the iteration termination condition is satisfied, terminating an execution; in response to determining that the iteration termination condition is not satisfied, continuing to execute a reference pose transform data update operation.

20. A non-transitory computer-readable storage medium having computer instructions stored thereon, wherein the computer instructions are configured to cause a computer to perform:
determining reference pose data of each of bone nodes when driving a skinned mesh bone model of a virtual avatar to a target patch model with a same topology;
synchronously driving the skinned mesh bone model according to the reference pose data of each of the bone nodes; and
updating the reference pose data of each of the bone nodes for subsequently driving the skinned mesh bone model.
